(19) United States
(12) Patent Application Publication
(10) Pub. No.: US 2009/0153543 A1
(43) Pub. Date: Jun. 18, 2009

(54) Driving Method of Plasma Display Panel and Plasma Display Device

(75) Inventors: Takashi Sasaki, Kunitomi (JP); Tetsuya Sakamoto, Kunitomi (JP); Naoki Itokawa, Kunitomi (JP); Takayuki Kobayashi, Kunitomi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: FUJITSU HITACHI PLASAMA DISPLAY LIMITED, Kanagawa (JP)

(21) Appl. No.: 12/092,831

(22) PCT Filed: Feb. 1, 2006
(86) PCT No.: PCT/JP2006/301680

§ 371 Date: May 7, 2008

(51) Int. Cl. G09G 5/00; G09G 3/28

(52) U.S. Cl. 345/214; 345/60

(57) ABSTRACT

In a technique of a PDP having a four-electrode structure of (X, Y, Z, and A), the technique capable of preventing a delay of a discharge timing due to a voltage applied to the Z electrode is provided. In the four-electrode product structure of (X, Y, Z, and A) and a PDP in which rows are formed at both sides of a Y electrode, for a voltage waveform applied to each electrode (for example, X1, Zo, Y1, Ze, X2, Zo, and Y2) from the drive circuit side, a voltage (Vt) of the narrow width trigger pulse (65) of a positive polarity applied to the Z electrode is configured to be a voltage higher than the voltage (Vs) of the sustain pulses of X and Y (45, 46, 55, and 56).

### TECHNICAL FIELD

The present invention relates to a driving method of a Plasma Display Panel (PDP) and a technique of a display device (Plasma Display Device: PDP device) for displaying a moving image on the PDP. More particularly, the present invention relates to a drive of the PDP having a four-electrode structure.

### BACKGROUND ART

As a structure of a conventional PDP device, there are an ordinary structure having a row (display line) formed with a first (X) electrode and a second (Y) electrode on the PDP, a structure (so-called ALIS structure) in which the X and Y electrodes are alternatively disposed and rows are formed between all adjacent electrodes, and the like.

In the PDP, an address discharge is executed between an address electrode (A) and the Y electrode, and a sustain discharge for display is executed between the X and Y electrodes. Further, there is a PDP having a structure in which a third (Z) electrode is further provided between the X and Y electrodes. This is a system in which, by a voltage applied to this Z electrode of the PDP, a preliminary-discharge (referred to as a trigger discharge) for the sustain discharge between the X and Y is caused between the Z electrode and the adjacent electrodes (Z and X/Y), that is, between the Z and X or between the Z and Y.

### DISCLOSURE OF THE INVENTION

### Problems to be Solved by the Invention

In the case of the driving method of the PDP having the four-electrode structure provided with the electrodes (X, Y, Z, and A) and the case of the PDP device, since there is a problem that the sustain discharge becomes unstable due to a discharge delay of the trigger discharge, it is necessary to control a timing of the trigger discharge with high accuracy. That is, it is necessary to prevent a delay of the timing of the trigger discharge.

The present invention has been made in view of the above described problem, and an object of the invention is to provide a technique capable of preventing a delay of the discharge timing due to the voltage applied to the third (Z) electrode in a technique of the PDP having the four-electrode structure.

### Means for Solving the Problems

Representative one of the inventions disclosed in the present application will be briefly described as follows. To achieve the above-described object, the present invention is a technique of the PDP with the structure having electrodes (X, Y, Z, and A), and comprises technical means described as follows.

The PDP includes: on a first substrate, a first (X) electrode group and a second (Y) electrode group in which a plurality of electrodes extending in a first (lateral) direction are disposed approximately in parallel for executing a discharge for display; a third (Z) electrode group disposed in a gap (discharge gap) between the X and Y electrodes where the discharge are executed; and a first dielectric layer and a protective layer covering the X to Z electrode groups. Further, the PDP includes: on a second substrate opposed to the first substrate, a fourth electrode (address (A) electrode) group in which a plurality of electrodes extending in a second (longitudinal) direction approximately perpendicular to the lateral direction are disposed approximately in parallel; a second dielectric layer covering the A electrode group; barrier ribs disposed at both sides of the A electrode; and a phosphor layer formed between the barrier ribs and on the second dielectric layer. A display cell is formed in a region where the X, Z, Y, and A electrodes intersect.

The driving method of the PDP according to the present invention is configured such that when the sustain discharge (repetitive discharge) is executed between the X and Y electrodes (main discharge gap) by applying voltage waveforms to the electrode groups of the PDP, prior to generation of a potential difference (first potential difference) of the sustain discharge between the X and Y electrodes, in the Z electrode, the potential difference (second potential difference) between the X or Y electrode and the Z electrode (Z and X/Y, trigger discharge gap) is made larger than the first potential difference. In other words, in a vicinity of a rising of the sustain pulse applied to the X and Y electrodes, a trigger pulse with a voltage larger than the voltage of the sustain pulse is applied to the Z electrode. As a result, a delay of a timing of the voltage waveform in the Z and X/Y is prevented.

The PDP device according to the present invention is configured such that when the sustain discharge is executed between the X and Y electrodes, a first power source (voltages Vt and Vs2) of a positive polarity applied to the Z electrode group by a Z drive circuit is made higher than a second power source (voltages Vs and Vs1) of a positive polarity applied to the X and Y electrode groups by X and Y drive circuits.

The effects obtained by typical aspects of the present invention will be briefly described below. According to the present invention, the delay of the timing of the trigger discharge for the sustain discharge due to the voltage applied to the third (Z) electrode can be prevented, and as a result, the sustain discharge can be made stable so as to enhance a display quality.

### BRIEF DESCRIPTIONS OF THE DRAWINGS

FIG. 1 is a view showing a configuration of a PDP module and a PDP device according to an embodiment of the present invention;

FIG. 2 is a perspective view showing a partially exploded configuration of the PDP in the PDP device according to the embodiment of the present invention;

FIG. 3 is a longitudinal cross-sectional view showing a partial configuration of the PDP in the PDP device according to the embodiment of the present invention;

FIG. 4 is a plan view showing a display cell structure in the PDP device according to an embodiment of the present invention;

FIG. 5 is a view showing a field configuration concept in the PDP device according to the embodiment of the present invention;

FIG. 6 is a view showing a voltage waveform applied to an electrode group from each drive circuit side in a PDP device and a PDP driving method according to a first embodiment of the present invention;

FIG. 7 is a view showing a schematic configuration of a Z drive circuit in the PDP device according to the first embodiment of the present invention;

FIG. 8 is a view showing a drive timing of the Z electrode in the PDP device according to the first embodiment of the present invention;

FIG. 9 is a view showing a schematic configuration of an X(Y) drive circuit in the PDP device according to the first embodiment of the present invention;

FIG. 10 is a view showing a drive timing of an X(Y) electrode in the PDP device according to the first embodiment of the present invention;

FIG. 11 is a view showing a schematic configuration of a drive circuit Z in a PDP device according to a second embodiment of the present invention;

FIG. 12 is a view showing a drive timing of the Z electrode in the PDP device according to the second embodiment of the present invention;

FIG. 13 is a view showing a schematic configuration of a Z drive circuit in a PDP device according to a third embodiment of the present invention;

FIG. 14 is a view showing a drive timing of the Z electrode in the PDP device according to the third embodiment of the present invention;

FIG. 15 is a view showing a schematic configuration of a Z drive circuit in a PDP device according to a fourth embodiment of the present invention;

FIG. 16 is a view showing a drive timing of the Z electrode in the PDP device according to the fourth embodiment of the present invention;

FIG. 17 is a view showing a schematic configuration of a Z drive circuit in a PDP device according to a fifth embodiment of the present invention;

FIG. 18 is a view showing a drive timing of the Z electrode in the PDP device according to the fifth embodiment of the present invention;

FIG. 19 is a perspective view showing a partially exploded configuration of a PDP in a PDP device according to a sixth embodiment of the present invention; and

FIG. 20 is a view showing a voltage waveform applied to an electrode group from each drive circuit side in the PDP device and the PDP drive method according to the sixth embodiment of the present invention.

### BEST MODE FOR CARRYING OUT THE INVENTION

Hereinafter, embodiments of the present invention will be described in detail with reference to the drawings. Note that, the same components are denoted by the same reference numerals in principal throughout the drawings for describing the embodiments, and the repetitive description thereof will be omitted.

### First Embodiment

A first embodiment will be described with reference to FIGS. 1 to 10. In the first embodiment, as its feature, the driving method for a PDP 3 (FIGS. 1 to 4) of a four-electrode structure having (X, Y, Z, and A) is to prevent the delay of the timing of the trigger discharge between the Z and X/Y. For that purpose, as shown in FIG. 6 and the like, a voltage (Vt) of a pulse with a narrow width applied to Z for the trigger discharge prior to the sustain discharge (main discharge) of (X and Y) during a sustain period (Ts) is configured to be larger than a voltage (Vs) of the sustain pulse of (X and Y).

### <PDP Device>

FIG. 1 shows a block configuration of a PDP module which is a configuration example of a PDP device of an AC type with the four-electrode structure in the first embodiment of the present invention. The present PDP module includes a PDP 3, a power source circuit 8, a control circuit 7; and an X drive circuit 4, a Y drive circuit 5, a first Z drive circuit 9, a second Z drive circuit 10 and an address drive circuit 6, all of which are drive circuits. For example, the present PDP module has a structure in which the PDP 3 is fixed with a substrate mounted with each of the above described circuits and the like, a chassis, and the like. Each of the electrode groups of the PDP 3 is electrically connected to each of the corresponding drive circuits. A PDP device product (set) is configured by the present PDP module being accommodated into an external casing.

The power source circuit 8 supplies power to the control circuit 7 and the like. The control circuit 7 controls each of the drive circuits (4, 5, 9, 10, and 6). The control circuit 7 and each of the drive circuits may be also integrally combined. Each of the drive circuits generates and supplies the voltage of a drive waveform to a corresponding electrode based on control from the control circuit 7. Further, an output terminal of the drive circuit and the electrode of the PDP are electrically connected through a wire of a flexible substrate and the like.

The X drive circuit 4 supplies a predetermined voltage to a plurality of X electrodes (sustain electrodes) {X1, X2 . . . } of the PDP3. Each of the X electrodes {X1, X2 . . . } or a generic term of these electrodes is expressed by X. The Y drive circuit 5 supplies a predetermined voltage to a plurality of scan electrodes (Y electrode) {Y1, Y2 . . . } of the PDP 3. Each of the Y electrodes {Y1, Y2 . . . } or a generic term of these electrodes is expressed by Y. The first Z drive circuit 9 supplies a predetermined voltage to odd (o) numbered Z electrodes (trigger electrodes) {Zo} of the PDP3. The second Z drive circuit 10 supplies a predetermined voltage to even (e) numbered Z electrodes (trigger electrodes) {Ze} of the PDP3. Each of the Z electrodes (Zo and Ze) or a generic term of these electrodes is expressed by Z (Zo and Ze). The address drive circuit 6 supplies a predetermined voltage to a plurality of address electrodes {A1, A2 . . . } of the PDP 3. Each of the address electrodes {A1, A2, . . . } or a generic term of these electrodes is expressed by A.

That is, the PDP 3 of the four-electrode structure includes the address electrode (A), the X electrode (X), the Y electrode (Y), and the Z electrode (Z). The Z electrode (Z) is provided so as to be positioned in a gap (discharge gap) between the X electrode (X) and the Y electrode (Y). Regions intersected by (X-Zo-Y and A) and (Y-Ze-X and A) correspond to display cells (C), respectively.

In the PDP 3, (X, Z, and Y) extend in parallel in the lateral (first) direction so as to form the row (display line), and the address electrode (A) extends in the vertical (second) direction so as to form the column. The address electrode (A) is disposed so as to intersect X-Z-Y. The plurality of (X, Y, and Z) are alternatively disposed in such a manner as to be {X1, Zo, Y1, Ze, X2, Zo, Y2, . . . } from the above in the second direction. The i number of Y electrodes Yi and the j number of address electrodes Aj form a two-dimensional matrix of the i rows and the j columns. For example, a display cell C11 is formed with an intersecting point of Y1 and A1, and Zo and X1 corresponding to and adjacent to the intersecting point. Such display cell is associated with a pixel. With this two-dimensional matrix, the PDP 3 can display a two-dimensional image. The Zo is, for example, an electrode for assisting the discharge between X1 and Y1, and the Ze is, for example, an electrode for assisting the discharge between Y1 and X2.

### <PDP>

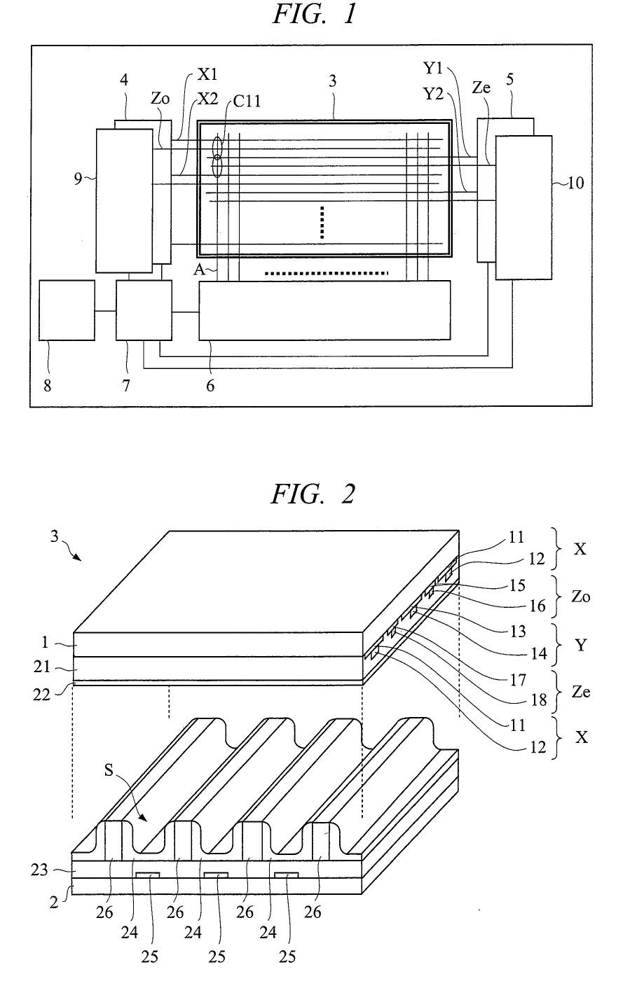

FIG. 2 shows a structural example of the PDP 3 according to the present embodiment. Each electrode (11 to 18) of the X, Y, and Z are formed on a front glass substrate 1. On the substrate, a dielectric layer 21 for insulating a discharge space (S) is deposited. Further, on that layer, for example, a protective layer 20 composed of MgO (magnesium oxide) is deposited.

The X electrode is, for example, configured by an X transparent electrode 11 and an X bus electrode 12. The Y electrode is, for example, configured by a Y transparent electrode 13 and a Y bus electrode 14. The odd numbered Z electrode (Zo) is, for example, configured by a Z transparent electrode 15 and a Z bus electrode 16. The even numbered Z electrode (Ze) is, for example, configured by a Z transparent electrode 17 and a Z bus electrode 18. In the above types of the electrodes, the bus electrode made of metal has a lower electrical resistance value than that of the transparent electrode (also referred to as a display electrode).

On the other hand, on a back glass substrate 2 disposed in opposition to the front glass substrate 1, an address electrode (A) 25 is formed. On the electrode, a dielectric layer 23 is deposited. Further, on the dielectric layer 23, a barrier rib 26 extending in a longitudinal direction in a stripe shape is provided so as to partition the discharge space (S) corresponding to the display cell. The region partitioned by the barrier rib 26, that is, on each side face of the barrier rib 26 and an upper surface of the dielectric layer 23, a phosphor 24 of each color R (red), G (green), and B (blue) is applied and arranged in a distinctively stripe shape. The phosphor 24 of each color is excited by the sustain discharge between the X electrode (particularly 12) and the Y electrode (particularly 14), so that each color emits light. In the discharge space (S) between the front glass substrate 1 and the back glass substrate 2, a Ne+Xe penning gas (discharge gas) and the like are sealed. Each type of the electrode groups (X, Y, Z, and A) is formed in the same process. In addition, as a rib structure, a lattice-like structure provided not only with the barrier rib 26 in the longitudinal direction but also with the barrier rib extending in the lateral direction is also possible.

<PDP Cross Section>

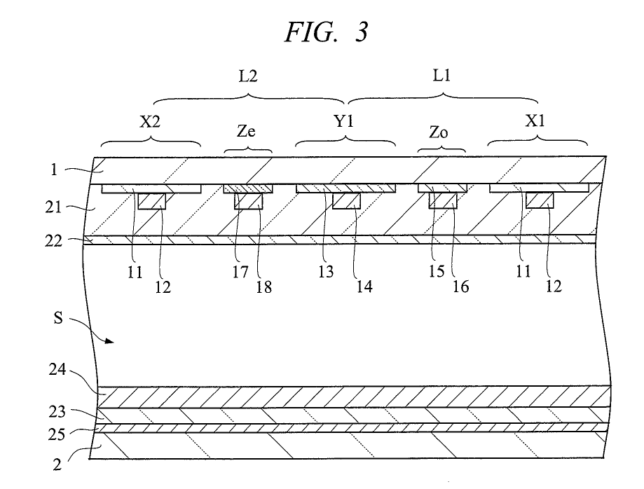

FIG. 3 shows a partial cross-section of the PDP 3 taken along the address electrode 25 in the second direction corresponding to FIG. 2. For example, two adjacent rows (L1 and L2) between X1 to X2 are shown. This is a structure in which Y1 serving as a scan electrode (display electrode applied with a scanning pulse) is shared in common by X1 and X2 serving as the sustain electrodes (display electrodes not applied with a scanning pulse). L1 is formed between X1 and Y1, and L2 is formed between Y1 and X2. L1 becomes an odd numbered row, and L2 becomes an even numbered row. In each row, Z (Zo and Ze) serving as an electrode (trigger electrode) for the trigger discharge is disposed between the Y and X. Zo is disposed between the Y1 and X1, and Ze is disposed between the Y1 and X2.

<Display Cell>

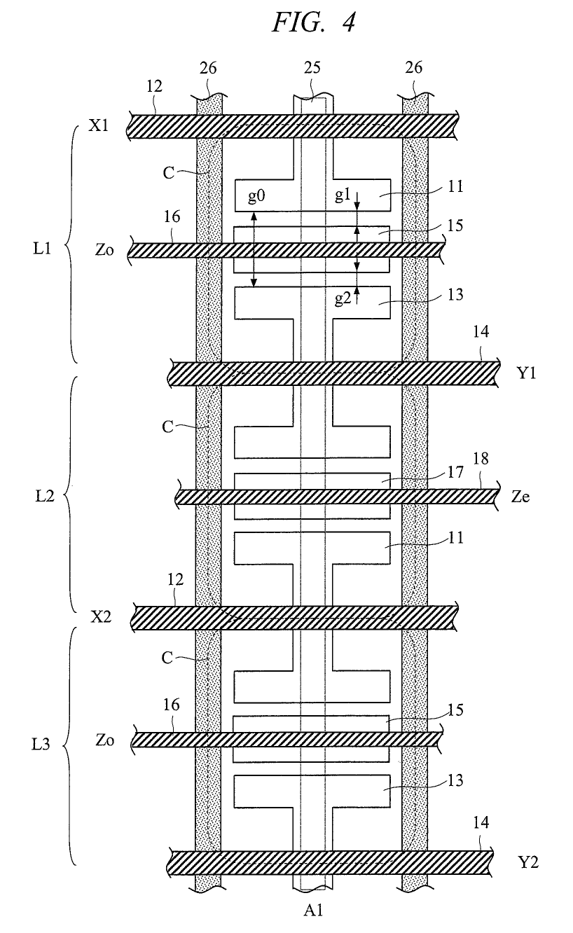

FIG. 4 shows a structural example of the display cell (C) of the PDP 3 corresponding to FIGS. 1 to 3, and shows a partial plan viewed from a vertical direction of the PDP 3 surface. As an example, a portion corresponding to X1 to Y1 (rows (L1 to L3)) is shown.

The region partitioned by the barrier rib 26 and the X and Y bus electrodes (12 and 14) are associated with the display cell (C). Between the barrier ribs 26, the address electrode 25 (for example, A1) is disposed.

The X bus electrode 12 constituting X1 is connected to the X drive circuit 4 side, and is applied with an X voltage waveform. The Y bus electrode 14 constituting Y1 is connected to the Y drive circuit 5 side, and is applied with a Y voltage waveform. The Z bus electrode 16 constituting Zo is connected to the Zo drive circuit 9 side, and is applied with a Zo voltage waveform. The Z bus electrode 18 constituting Ze is connected to the Ze drive circuit 10 side, and is applied with a Ze voltage waveform.

The X transparent electrode 11 constituting X1 is electrically connected to the X bus electrode 12. The Y transparent electrode 13 constituting Y1 is electrically connected to the Y bus electrode 14. The Z transparent electrode 15 constituting Zo is electrically connected to the Z bus electrode 16. The Z transparent electrode 17 constituting Ze is electrically connected to the Z bus electrode 18. The X and Y transparent electrodes (11 and 13), in the present embodiment, have a shape protruding both up and down sides in the longitudinal direction in a T-shape. In addition, corresponding to this, the Z transparent electrodes (15 and 17) of Zo and Ze, in the present embodiment, have a shape slightly protruding both up and down sides in the longitudinal direction in a rectangle shape. Note that, the shape and the like of each transparent electrode are only one example, and can be also modified.

In between X and Y, between the X transparent electrode 11 and the Y transparent electrode 13, edges of these electrodes are opposed to each other, so that a discharge gap (gO) for the sustain discharge (main discharge) is formed as shown by an arrow. Further, in between Z and X, and in between Z and Y, between adjacent transparent electrodes, edges of these electrodes are opposed to each other, so that discharge gaps (g1 and g2) for the trigger discharge for the sustain discharge are formed as shown by arrows.

<Field>

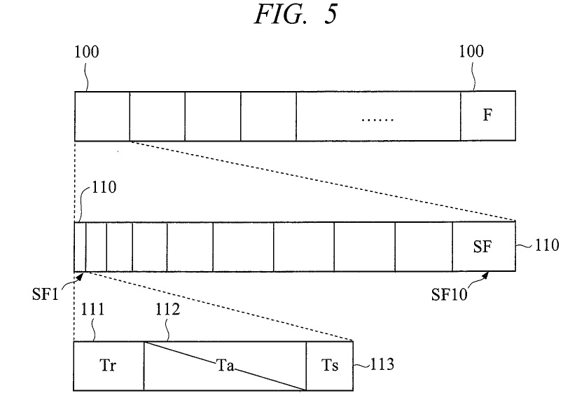

FIG. 5 shows a configuration example of a filed (F) 100 corresponding to a display image of the PDP 3 in the present PDP device. Each F100 is configured by a plurality of sub fields (SF) 110, for example, 10 pieces of SF110 {[SF1], [SF2], . . . , and [SF10]}. Each SF110 is given a different weighting for a gray scale expression. The SF number is equivalent to the number of gray scale bits. A gray scale value can be decided by a combination of SF110s lighted and displayed on F100. Each F100 can display one piece of an image, which is displayed at 60 F/sec.

Each SF110 is configured by a reset period (Tr) 111, an address period (Ta) 112, and a sustain period (Ts) 113. Trill is a period in which an initialization operation (or an addressing preparation) of the display cell (C) is performed. In Ta112, by the address discharge between A and Y, emission (lighting)/non-emission (non-lighting) of each display cell (C) can be selected (addressing). Specifically, a scanning pulse is applied to the Y electrodes {Y1, Y2, Y3, Y4, . . . } and the like in order, and an address pulse corresponding to the scanning pulse is applied to the address electrode 25. At the same time, the potential of X is made to be a potential capable of being discharged with Y, and when the discharge between A and Y is taken as a trigger, the discharge between X and Y is executed, so that emission or non-emission of the desired display cell (C) can be selected. In Ts113, by using X, Y, and Z, the sustain discharge is executed between X and Y of the display cell (C) selected in Ta112, so that emission of the display cell (C) is performed. Each SF110 is different in the number of emissions time (length of Ts113) due to the sustain pulse applied to X and Y in Ts113.

<Voltage Waveform>

FIG. 6 shows an example of the voltage waveform (drive waveform) applied to each electrode in the PDP driving method of the first embodiment. An example of the voltage waveform corresponding to Tr111, Ta112 and Ts113 of SF110 in Y1 to Y2 and A is shown. Vx1 is the voltage waveform of X1. Vx2 is the voltage waveform of X2. Vy1 is the voltage waveform of Y1. Vzo is the voltage waveform of Zo. Vze is the voltage waveform of Ze. Va is the voltage waveform of the address electrode (A) 25. In other electrodes, the same voltage waveform is applied thereto.

FIG. 6 shows the voltage waveforms at the time of the discharge (display) between X1 and Y1 and between X2 and Y2, that is, at Zo and odd numbered row sides. Therefore, in Vze at Y1 and X2 side which is the other side, that is, Ze and the even numbered side, a grand (GND) potential (81) should be maintained at all the times. On the contrary, in the voltage waveform at the time of the discharge between the Y1 and X2, that is, Ze and the even numbered row side, the grand potential (81) is maintained as Vzo at the other side.

Hereinafter, the waveform of each period will be described. First, in Tr111, a write voltage 41 and an adjusting voltage 42 are applied as Vx1. The same voltages are applied as Vx2. Further, a write slope voltage 51 and an adjusting slope voltage 52 are applied as Vy1. As a result, between X1 and Y1, and X2 and Y1, a write discharge and an adjusting discharge for reset are generated. As Vzo, as with the write voltage 41 and the adjusting voltage 42 of Vx1, a write voltage 61 and an adjusting voltage 62 are applied, so that the same discharge as X1 is generated. This holds true with Vx2 to Vy2.

Next, in Ta112, as Vx1, a scan time voltage 43 is applied. As Vx2, the scan time voltage 43 is applied. The scan time voltage 43 is applied separately in a front half and a rear half of Ta112. Further, as Vy1, a scan pulse 53 is applied. Specifically, the scan pulse 53 is alternately applied to the Y electrodes {Y1, Y3, Y5, Y7, . . . , Y2, Y4, Y6, Y8, . . . } and the like in order. Further, as Va, an address plus 74 is applied to the display cell (C) of the selection target while synchronizing with the scan pulse 53 of each row.

In the front half of Ta112, when the address pulse 74 is applied corresponding to the scan pulse 53, a discharge is generated between Y1 and A. With the discharge as priming particles, a discharge is generated between X1 and Y1, and a wall charge is generated in vicinities of X1 and Y1. At this time, no discharge is generated between X2 and Y1. This is performed between each Xi and Yi (i is an odd number). In the rear half of Ta112, when the address pulse 74 is applied corresponding to the scan pulse 53, the discharge is generated between Y2 and A. With the discharge as priming particles, the discharge is generated between X2 and Y2, and the wall charge is generated in vicinities of X2 and Y2. At this time, no discharge is generated between X3 and Y2. This is performed between each Xj and Yj (j is an even number). In Vzo for Zo, a scan time voltage 63 is applied in a similar way of the adjacent X (X1 and X3).

Next, in Ts113, as Vx1, repetitive sustain pulses 45 and 46, and an erase pulse 47 are applied. The repetitive sustain pulses 45 and 46 are such that the pulses are repeatedly applied with its polarity alternatively reversed (the negative sustain pulse 45 and the positive sustain pulse 46). Further, as Vy, as with Vx, repetitive sustain pulses 55 and 56 and an erase pulse 57 are applied. The repetitive sustain pulses 55 and 56 are such that the pulses are repeatedly applied with its polarity alternatively reversed (the positive sustain pulse 55 and the negative sustain pulse 56), and also such that the pulses are reversed in polarity with respect to the repetitive sustain pulses 45 and 46 of Vx. Here, voltages of the repetitive sustain pulses (45, 46, 55, and 56) in the present embodiment are ±Vs, and as one example is Vs=85 [V]. Further, the erase pulse (47 and 67) applied to an end of Ts113 is to reduce the wall charge. This is not limited to the present embodiment, there are also various systems such as a thin line erase system, a wide width erase system, and a self erase system. However, any of the systems does not erase the wall charge completely, but only reduces the amount thereof.

As Vzo, while matching the initial sustain pulse 45 of Vx1, a trigger pulse 64 having the same potential is applied. Subsequently, prior to the positive sustain pulse 46 (and the negative sustain pulse 56), a positive trigger pulse 65 is applied, and approximately at the same time as the sustain discharge of between X and Y starts, a negative trigger pulse 66 is applied. Although the negative trigger pulse 66 has the same voltage −Vs as the sustain pulse dose, the positive trigger pulse 65 has a voltage (expressed by Vt) higher than the voltage Vs of the sustain pulse, which is different from conventional one. As a result, the discharge delay of the trigger discharge prior to the sustain discharge can be reduced. This holds true with each of the subsequent trigger pulses (65 and 66). After that, the same erase pulse 67 as the erase pulse 47 of Vx1 is applied.

In Vx2, repetitive sustain pulses 85 and 86 (negative sustain pulse 85 and positive sustain pulse 86) are applied while synchronizing with the sustain pulse 56 of the negate polarity of Vy1 so as not to generate a discharge with Vy1. In this case, Vx2 and Vy1 are at the same potential, except for the initial (sustain pulse 55 and GND potential) and the last (GND potential and positive sustain pulse 96), and no discharge occurs between X2 and Y1. In addition, to match the number of discharge times at each row (display line), the positive sustain pulse 96 is finally applied (in the present embodiment, the sustain pulses of a total of six times). In Vy2, the repetitive sustain pluses 95 and 96 of the reverse polarity (positive sustain pulse 95 and negative sustain pulse 96) are applied corresponding to Vx2. Vzo between X2 and Y2 is the same as the Vzo between X1 and Y1.

<Z Drive Circuit>

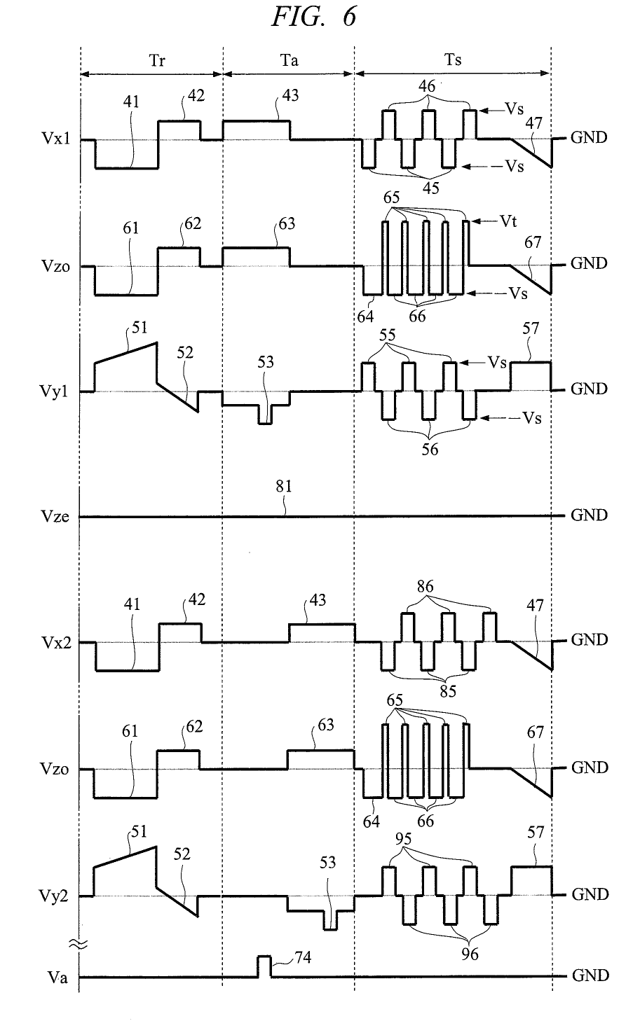

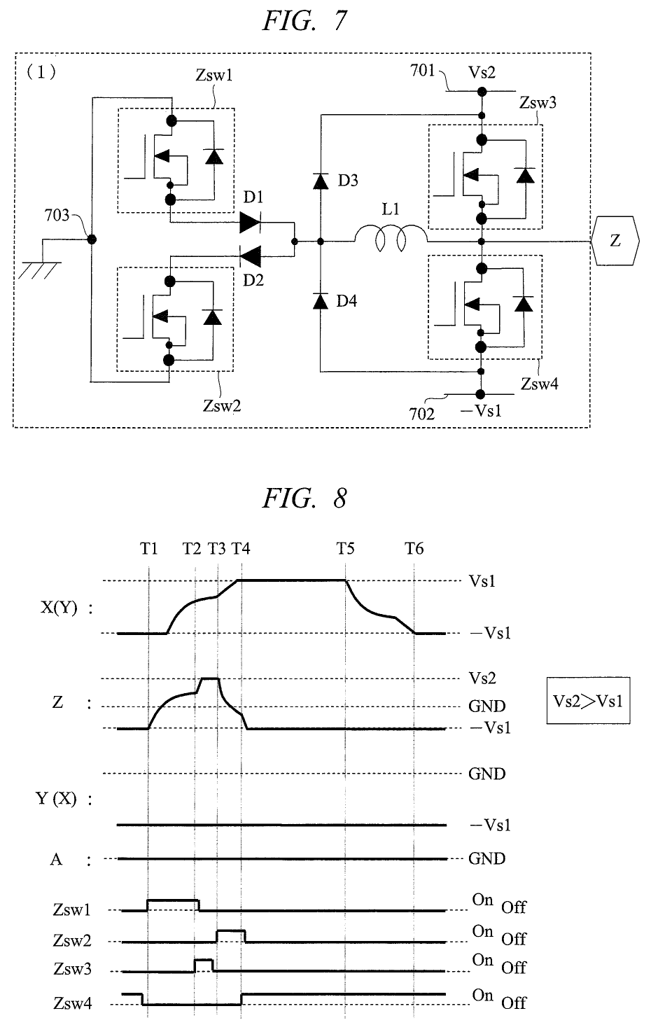

FIG. 7 shows a schematic configuration of a circuit (corresponding to Z drive circuits 9 and 10) applying a voltage to the Z electrode (Z). The present circuit is configured by a coil L1, switches Zsw1 to Zsw4, diodes D1 to D4, a Vs2 power source 701, a −Vs1 power source 702, and the like.

The Vs2 power source 701 supplies a voltage Vs2 corresponding to the voltage Vt of the positive trigger pulse 65 of FIG. 6. The −Vs1 power source 702 supplies a voltage −Vs1 corresponding to the voltage −Vs of the negative trigger pulse 66 of FIG. 6.

The switches Zsw1 to Zsw4 are composed of a MOSEET element, respectively, and a diode is connected between a source and drain. A halfway point (potential 703) between the drain of the switch Zsw1 and the source of the switch Zsw2 is made to have an approximately intermediate potential between Vs2 and −Vs1. The source of the switch Zsw1 is connected to one end of the coil L1 through the diode D1 of forward connection. The one end of the coil L1 is connected to the drain of the switch Zsw2 through the diode D2 of forward connection.

The drain of the switch Zsw3 is connected to the Vs2 power source 701. The source of the switch Zsw4 is connected to the −Vs1 power source 702. The source of the switch Zsw3 and the drain of the switch Zsw4 are both connected to the other end of the coil L1 in common, and this common connecting point serves as an output terminal of a Z pulse (voltage waveform applied to the Z electrode). The diode D3 is connected to the one end of the coil L1 in a reverse direction from the Vs2 power source 701. The diode D4 is connected to the −Vs1 power source 702 in a reverse direction from the one end of the coil L1.

Particularly, this Z drive circuit was conventionally configured only by switches equivalent to the switches Zsw3 and Zsw4. On the other hand, in the present first embodiment, the Z drive circuit is configured by the coil L1, which utilizes LC resonance operation with a capacity (capacity between Z and X/Y of the display cell (C)) of the PDP 3, and the switches Zsw1 to Zsw4 to generate the Z pulse and applies it to the PDP3. In the switches Zsw1 and Zsw2, the MIOSEFT elements are disposed in parallel as Z power recovery switches. The coil L1 is disposed as a resonance coil in which a route for charging and discharging of electrical charges with respect to the capacity of the PDP 3 is in one common series.

<Z Drive Timing>

Next, FIG. 8 shows an On/Off timing of each element of the Z drive circuit of FIG. 7 and a detail of the voltage waveform of each electrode and a timing of the discharge. [X(Y)] and [Y(X)] in FIG. 8 show details of the pulses corresponding to the sustain pulses (45, 46, 55, and 56) in FIG. 6, and [Z] shows a detail of the pulse corresponding to the trigger pulses (64, 65, and 66) in FIG. 6. [Zsw1] to [Zsw4] in FIG. 8 correspond to operations of the switches Zsw1 to Zsw4 of FIG. 7. Each T shows timing.

The Z pulse is applied prior to the sustain pulse of X(Y), and the trigger discharge is set to occur while overlapping a rising (T1 to T4) of the sustain pulse of X(Y). The sustain pulse of X(Y) has a voltage −Vs1 before the rising, and has a voltage Vs1 after the rising. The pulse of Z has a voltage −Vs1 before the rising, and has a voltage Vs2 after the rising. A period in which Z is Vs2 and a period in which X(Y) is Vs1 are set so as not to be overlapped. The condition is Vs2>Vs1.

Prior to the raising of the sustain pulse of X(Y), first, the switch Zsw1 is turned on (T1) to raise the voltage of the Z pulse (T1 to T2). Subsequently, the switch Zsw3 is turned on (T2) to raise the voltage applied to the Z electrode up to Vs2 (T2 to T3). At this time, the switches Zsw1 and Zsw3 may be turned on at the same time. Next, the switch Zsw3 is tuned off (T2 to T3), and after that, the switch Zsw2 is turned on (T3). At this time, the switch Zsw1 is in off-state. As a result, the voltage applied to the Z electrode is lowered (T3 to T4). After that, the switch Zsw4 is turned on (T4), and the voltage applied to the Z electrode is lowered to the original voltage −Vs1. As a result, the Z pulse (trigger pulse 65) of the positive polarity having the narrow pulse width can be generated.

To realize high speed characteristics, the Z pulse having the narrow pulse width is set such that its pulse width is ended at the time (T3 to T4) before the time (T5 to T6) of completion of discharge emission started by the sustain pulse of X(Y). As an example, the pulse width is approximately 100 ns to 1000 ns. Charging to the capacity of the PDP 3 is executed by this rising of the Z pulse, and discharge the capacity of the PDP3 is executed by the fall thereof.

<X(Y) Drive Circuit>

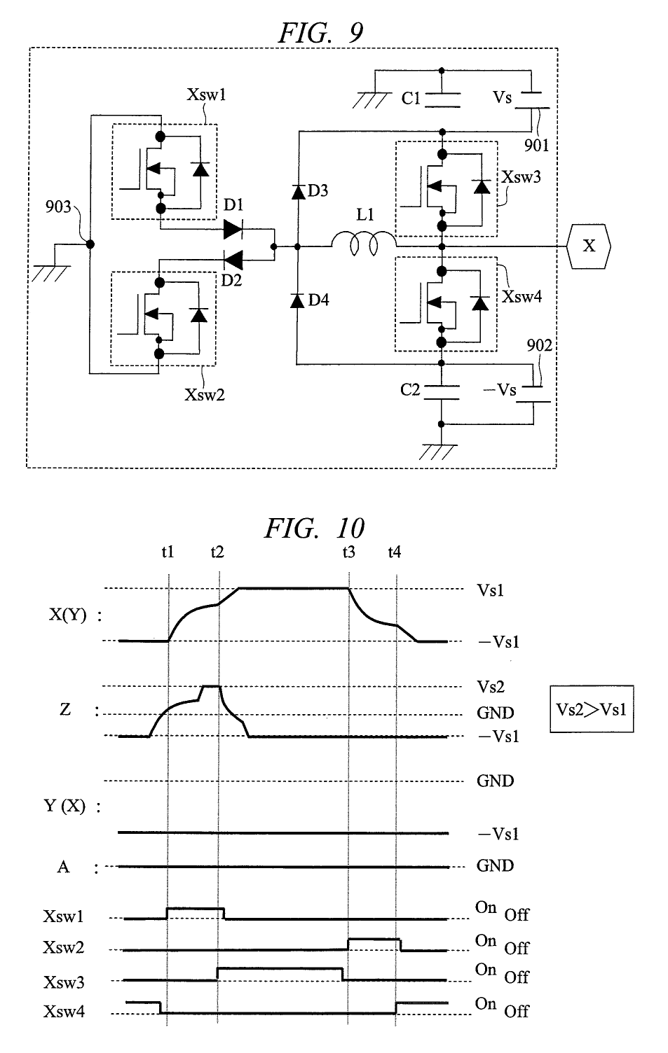

FIG. 9 shows a schematic configuration of a circuit (corresponding to the X drive circuit 4 (the Y drive circuit 5)) applying a voltage to the X(Y) electrode. The configuration is the same in X and Y. This circuit is configured by the coil L1, the switches Xsw1 to Xsw4, the diodes D1 to D4, a Vs power source 901, a −Vs power source 902, capacitors C1 and C2, and the like.

The Vs power source 901 supplies a voltage (Vs1 in FIG. 7) corresponding to the voltage Vs of the sustain pulse of FIG. 6. The −Vs power source 902 supplies a voltage (−Vs1 in FIG. 7) corresponding to the voltage −Vs of the sustain pulse of FIG. 6.

Switches Xsw1 to Xsw4 are composed of the MOSFET element, respectively, and the diode is connected between the source and drain. A halfway point (potential 903) between the drain of the switch Xsw1 and the source of the switch Xsw2 is made to have an approximately intermediate potential between Vs and −Vs. The source of the switch Xsw1 is connected to one end of the coil L1 through the diode D1 of forward connection. The one end of the coil L1 is connected to the drain of the switch Xsw2 through the diode D2 of forward connection.

The drain of the switch Xsw3 is connected to the Vs power source 901 and the capacitor C1 both disposed in parallel with the grand. The source of the switch Xsw4 is connected to the −Vs power source 902 and the capacitor C2 both disposed in parallel with the grand. The source of the switch Xsw3 and the drain of the switch Xsw4 are connected to the other end of the coil L1 in common, and this common connecting point serves as an output terminal of the X(Y) pulse (voltage waveform) The diode D3 is connected to the one end of the coil L1 in a reverse direction from the Vs power source 901. The diode D4 is connected to the −Vs power source 902 in a reverse direction from the one end of the coil L1.

<X(Y) Drive Timing>

Next, in FIG. 10, as with FIG. 8, details of on/off timing of each element of the X(Y) drive circuit, and the voltage waveform and the discharge timing of each electrode are shown. Each t shows timing. in FIG. 10.

First, the switch Xsw1 is turned on (t1) to raise the voltage of the X(Y) pulse (t1 to t2). Subsequently, the switch Xsw3 is turned on (t2), and the voltage applied to the X(Y) electrode is raised up to Vs. At this time, the switches Xsw1 and Xsw3 may be turned on at the same time. Next, the switch Xsw3 is tuned off, then, the switch Xsw2 is turned on (t3). At this time, the switch Xsw1 is in off-state. As a result, the voltage applied to the X(Y) electrode is lowered (t3 to t4). After that, the switch Xsw4 is turned on (t4), and the voltage applied to the X(Y) electrode is lowered to the original voltage −Vs. As a result, the sustain pulse of the positive polarity is generated. This holds true with the Y drive circuit side.

By the above described drive circuit, the voltages applied to the X(Y) and Z electrodes in Ts113 satisfy the condition of Vs2>Vs. Here, −Vs1=−Vs. As a result, when the Z pulse (trigger pulse 65) of the positive polarity is applied, a potential difference, which is larger than that at the sustain discharge time between X and Y, occurs with the Y(X) electrode serving as a cathode (negative electrode).

Consequently, displacement and fluctuation of a generating timing of the conventional trigger discharge, particularly the trigger discharge delay (delay toward the right direction of FIG. 8) can be reduced. That is, the sustain discharge by the X(Y) sustain pulse can be stabilized.

### Second Embodiment

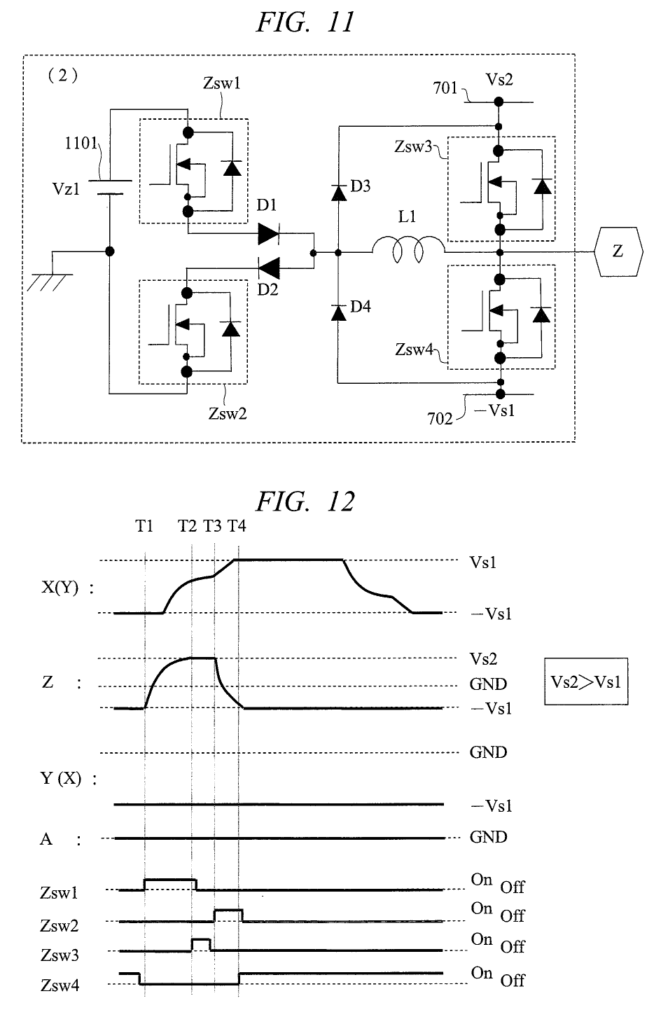

Next, another embodiment as a modification example of the first embodiment will be described. FIG. 11 shows a Z drive circuit in a second embodiment. FIG. 12 shows a Z drive timing and the like in the second embodiment. In FIG. 11, a configuration of the second embodiment is an example in which a Vz1 power source 1101 is added to the configuration of FIG. 7. The Vz1 power source 1101 is connected between the drain of a switch Zsw1 and the source of a switch Zsw2. The Vz1 power source 1101 supplies a voltage Vz1. That is, the capacity of the PDP3 is charged by LC resonance characteristics between a PDP3—the circuit, and moreover, the Vz1 power source 1101 raising its resonance point is provided. By this configuration, with the LC resonance with the coil L1 and the capacity of the PDP3, the voltage of Z can be raised close to Vs2. Since the voltage applied to L1 can be raised by the voltage Vz1, the LC resonance voltage is also raised. In FIG. 12, by the switch operation in the similar way of the first embodiment, as shown in the rising of the pulse of Z, the voltage is raised from −Vs1 to Vs2 at the timing between T1 and T2.

### Third Embodiment

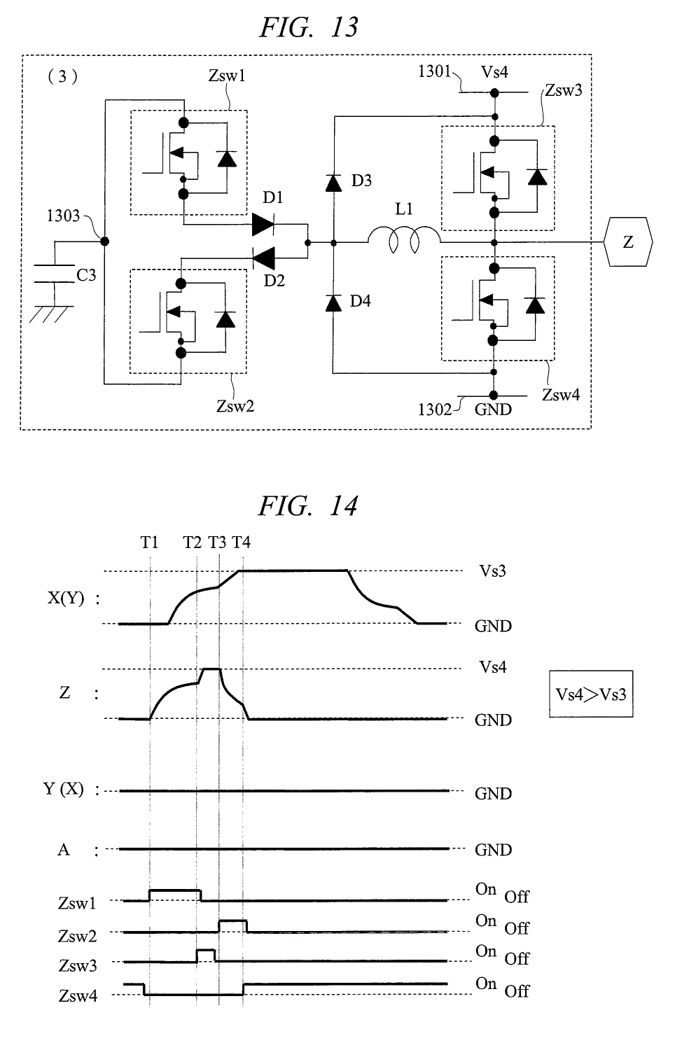

FIG. 13 shows a Z drive circuit in a third embodiment. FIG. 14 shows a Z drive timing and the like in the third embodiment. In FIGS. 13 and 14, a configuration of the third embodiment is an example in which the sustain pulse is configured by 0 V (GND) to Vs3. The Z pulse is configured by 0 V (GND) to Vs4 (Vs4>Vs3). In FIG. 13, as a power source, in place of the Vs2 power source 701 and the −Vs power source 702, a Vs4 power source 1301 and a ground 1302 are provided. A halfway point (potential 1303) between the drain of the switch Zsw1 and the source of the switch Zsw2 is grounded through a capacitor C3. In FIG. 14, according to the switch operation as with the first embodiment, the sustain pulse of X(Y) has GND before the rising, and has Vs3 after the rising. The Z pulse has GND before the rising, and has Vs4 after the rising. The condition is Vs4>Vs3.

### Fourth Embodiment

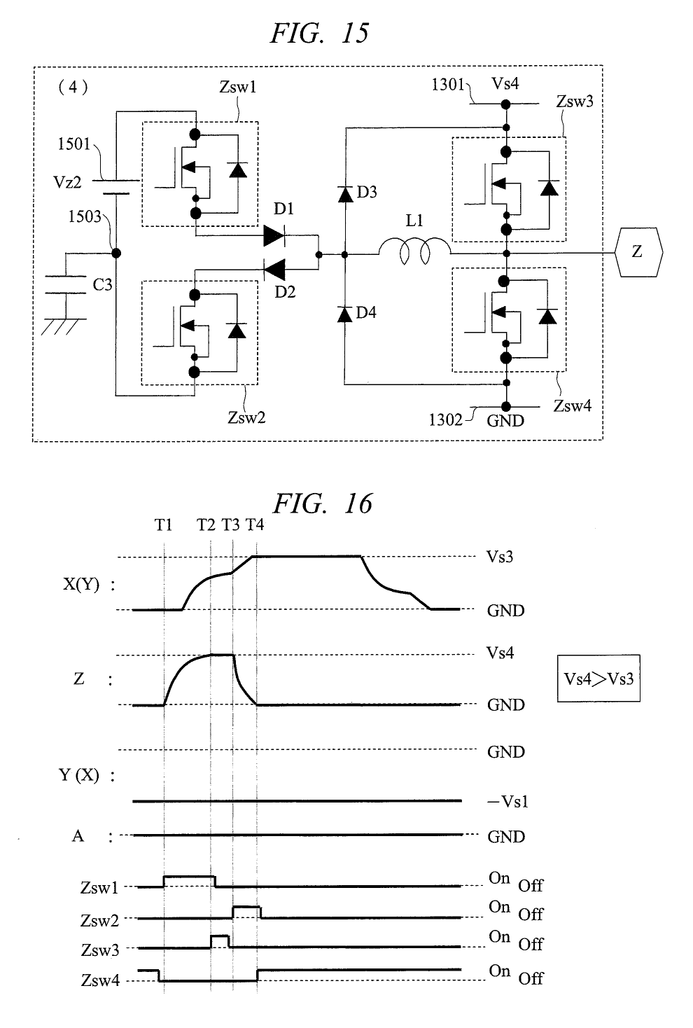

FIG. 15 shows a Z drive circuit in a fourth embodiment. FIG. 16 shows a Z drive timing and the like in the fourth embodiment. In FIG. 15, the fourth embodiment is an example in which a Vz2 power source 1501 is added to the configuration of the third embodiment in the same concept as the second embodiment. In FIG. 15, a halfway point (potential 1503) between the drain of the switch Zsw1 and the source of the switch Zsw2 is connected to the Vs2 power source 1501, and is grounded through the capacitor C3. In FIG. 16, a sustain pulse is formed of 0 V (GND) to Vs3, and a Z pulse is formed of 0 V (GND) to Vs4 (Vs4>Vs3). By this configuration, the voltage of Z can be raised close to Vs4 (T1 to T2) with the LC resonance between the coil L1 and the capacity of the PDP3 through the switch operation and action as with the second embodiment.

### Fifth Embodiment

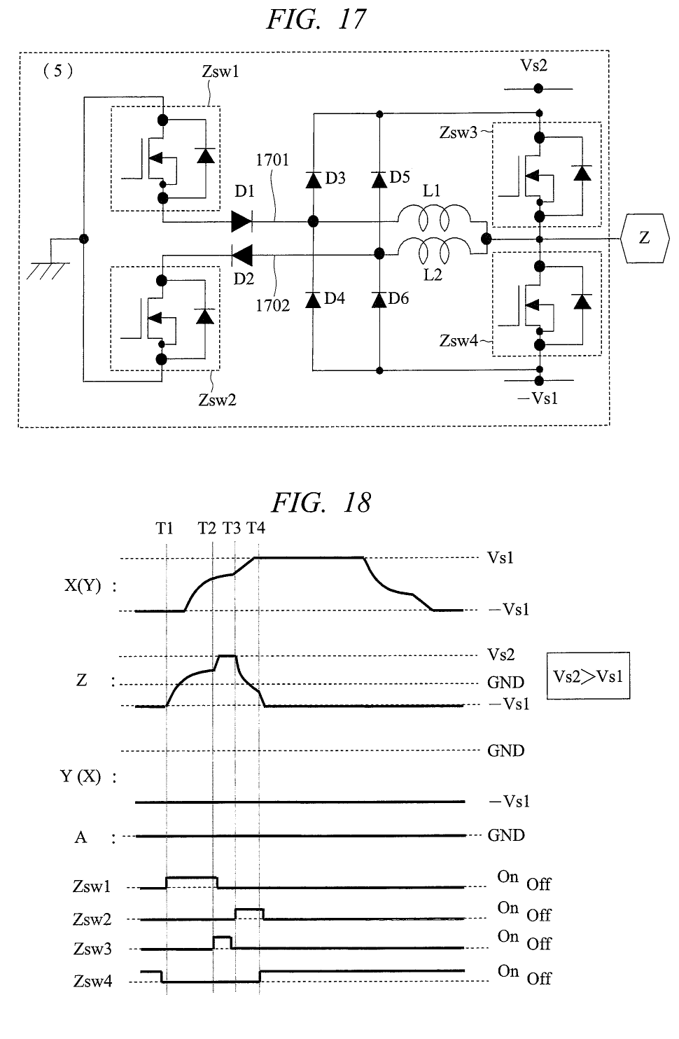

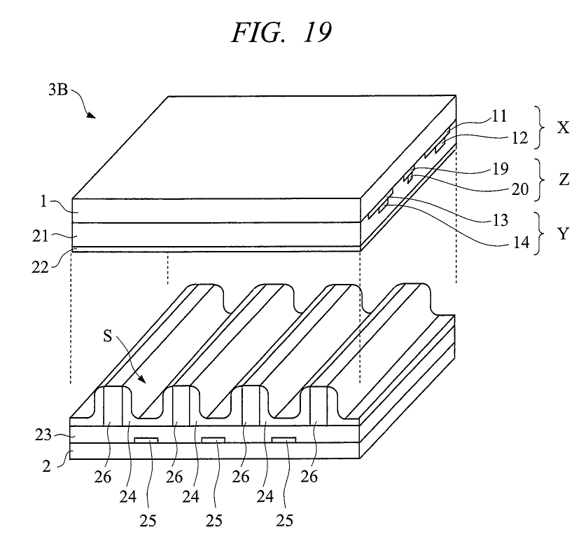

FIG. 17 shows a Z drive circuit in a fifth embodiment. FIG. 18 shows a Z drive timing and the like in the firth embodiment. In FIG. 17, in a configuration of the fifth embodiment, two types of coils L1 and L2 connected to Z are provided, and two routes for charging and discharging corresponding to these coils are separately provided. That is, in the Z drive circuit for applying the Z pulse, with LC resonance characteristics between the PDP3—the circuit, a first route (L1 side) 1701 for charging the capacity of the PDP3 and a second route (L2 side) 1702 for discharging the capacity of the PDP3 are provided. In FIG. 18, by this configuration, power recovery characteristics which are different between the charging (T1 to T2) of the Z pulse and discharging (T3 to T4) thereof can be designed.

### Sixth Embodiment

Next, a sixth embodiment which is a modification example different in a PDP and a driving system will be described. The technique of the first embodiment and its modification example is applicable to any structures other than the structure (so-called ALIS configuration) of the PDP3 capable of discharging at both sides (normal and reverse slits) of the Y electrode like FIG. 2. A configuration of the sixth embodiment applies a feature configuration of the Z pulse to a configuration of a PDP3B having an ordinary four-electrode structure as shown in FIG. 19, that is, a structure capable of discharging only at one side (normal slit) of the Y electrode, in other words, a structure in which the Ze electrode is not present.

In FIG. 19, in the PBP3B, an electrode group forming rows in which (X, Z, and Y) are considered one set is repeatedly formed on a front glass substrate 1 in a longitudinal direction. A back glass substrate 2 side is the same as described above. An X electrode is configured by an X transparent electrode 11 and an X bus electrode 12, and a Y electrode is configured by a Y transparent electrode 13 and a Y bas electrode 14, and a Z electrode disposed in a discharge gap between X and Y is configured by a Z transparent electrode 19 and a Z bus electrode 20. The X and Y each may be configured by one type.

The PDP device of the sixth embodiment includes an X drive circuit, a Y drive circuit, a Z drive circuit, and an address drive circuit, all of which are electrically connected corresponding to each type of the electrodes of the PDP3B and which apply a voltage waveform for driving. The configurations of the Z drive circuit and the X(Y) drive circuit can be similarly applied with the configurations (FIGS. 7, 9 and the like) of the first embodiment to the fifth embodiment.

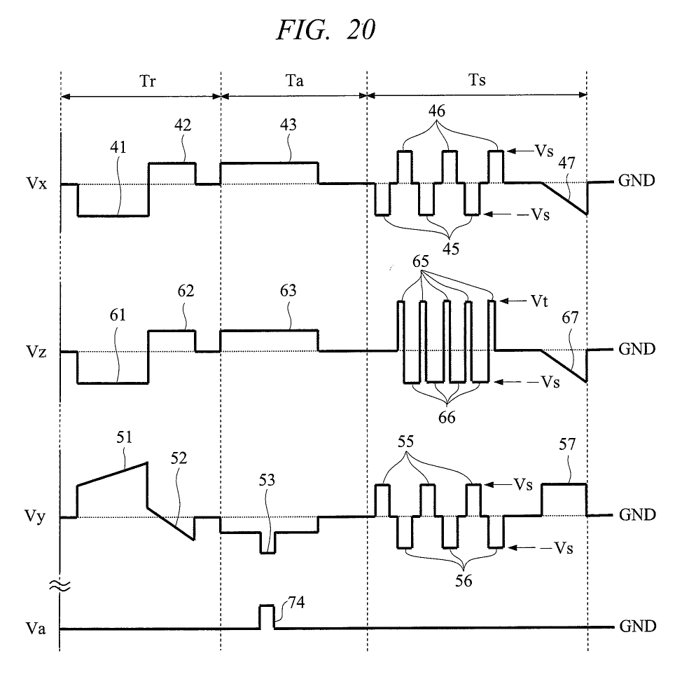

In FIG. 20, voltage waveforms {Vx, Vz, Vy, and Va} for driving the electrode group of the PDP3B are shown. The actions of Tr111 and Ta112 are the same as FIG. 6. In Ts113, in Vx and Vy, as with FIG. 6, alternatively repetitive sustain pulses (45, 46, 55, and 56) of opposite polarity are applied between X and Y. The voltages of these positive and negative sustain pulses are from −Vs to Vs. In Vz, as with FIGS. 6 and 8, at the timing prior to the sustain pulse, as the Z pulse for the trigger discharge between Z and X/Y, the trigger pulses (65 and 66) are applied. The voltage of this Z pulse is from −Vs to Vt.

According to the sixth embodiment, as with the first embodiment and the like, the displacement and the fluctuation of the generating timing of the trigger discharge can be reduced, and the sustain discharge due to the X(Y) sustain pulses can be stabilized.

According to each embodiment as described above, the delay of the trigger discharge can be reduced so as to stabilize the sustain discharge, and the display quality of the PDP can be enhanced.

In the foregoing, the invention made by the present inventors has been concretely described based on the embodiments. However it is needless to say that the present invention is not limited to these embodiments and various modifications and alterations can be made within the scope of the present invention.

1. A driving method of a plasma display panel including, on a first substrate, a first and a second electrode groups, for discharges, plurally extending in a first direction and disposed approximately in parallel, a third electrode group disposed in a gap between the first and the second electrodes, the discharge being executed in the gap, and a first dielectric layer and a protective layer covering the first to the third electrode groups, and further including, on a second substrate opposed to the first substrate, a fourth electrode group plurally extending in a second direction approximately perpendicular to the first direction and disposed approximately in parallel, a second dielectric layer covering the fourth electrode group, a barrier rib disposed at both sides of the fourth electrode, and a phosphor layer formed between the barrier ribs and on the second dielectric layer,
the method comprising the step of, when a sustain discharge is executed between the first and the second electrodes, before a potential difference of the sustain discharge between the first and the second electrodes is generated, making a potential difference between the first or the second electrode and the third electrode larger in the third electrode than the potential difference of the sustain discharge generated between the first and the second electrodes.

2. A plasma display device comprising:
a plasma display panel including: on a first substrate,
a first and a second electrode groups, for discharges, plurally extending in a first direction and disposed approximately in parallel;
a third electrode group disposed in a gap between the first and the second electrodes, the discharge being executed it the gap; and
a first dielectric layer and a protective layer covering the first to the third electrode groups;
the plasma display panel further including: on a second substrate opposed to the first substrate,
a fourth electrode group plurally extending in a second direction approximately perpendicular to the first direction and disposed approximately in parallel;
a second dielectric layer covering the fourth electrode group;
a barrier rib disposed at both sides of the fourth electrode; and
a phosphor layer formed between the barrier ribs and on the second dielectric layer;
a first drive circuit applying a voltage to the first electrode group;
a second drive circuit applying a voltage to the second electrode group;
a third drive circuit applying a voltage to the third electrode group; and
a fourth drive circuit applying a voltage to the fourth electrode group,
wherein, with application of voltage waveforms to the first to the fourth electrode groups of the plasma display panel from the first to the fourth drive circuit sides, when a sustain discharge is executed between the first and the second electrodes, before a potential difference of the sustain discharge between the first and the second electrodes is generated, a potential difference between the first or the second electrode and the third electrode is made larger in the third electrode than the potential difference of the sustain discharge generated between the first and the second electrodes.

3. The plasma display device according to claim 2,
wherein when the sustain discharge is executed between the first and the second electrodes, a first power source of a positive polarity applied to the third electrode group by the third drive circuit is made higher than a second power source of a positive polarity applied to the first and the second electrode groups by the first and the second drive circuits.

4. The plasma display device according to claim 2,
wherein in the third drive circuit, when the sustain discharge is executed between the first and the second electrodes, a circuit applying a potential of a positive polarity to the third electrode group includes a third power source which charges a capacity of the plasma display panel with LC resonance characteristics between the plasma display panel and the circuit, and which raises its resonance point.

5. The plasma display device according to claim 2,
wherein in the third drive circuit, when the sustain discharge is executed between the first and the second electrodes, a circuit applying a potential of a positive polarity to the third electrode group includes a first route which charges a capacity of the plasma display panel with LC resonance characteristics between the plasma display panel and the circuit, and a second route which discharges the capacity of the plasma display panel.
